(19) United States
(12) Patent Application Publication
(10) Pub. No.: US 2026/0277613 A1
(43) Pub. Date: Sep. 17, 2026

(54) SYSTEMS AND METHODS FOR GENERATING ALIGNED DATA FROM SEGMENTED DATA CHANNELS

(71) Applicant: ADVANCED MICRO DEVICES, INC., Santa Clara, CA (US)

(72) Inventors: Hideki Kanayama, Santa Clara, CA (US); Rohankumar Raosaheb Patil, Santa Clara, CA (US)

(21) Appl. No.: 19/079,800

(22) Filed: Mar. 14, 2025

(51) Int. Cl. G06F 9/38

(52) U.S. Cl. CPC G06F 9/3816; G06F 9/3814

(57) ABSTRACT

Systems and methods for generating aligned data from segmented data channels include a memory controller with one or more buffers. The memory controller stores mismatched, segmented chunks of data received from a memory in buffers such that, once a complete set of chunks for a value requested from memory is received, the memory controller outputs all of the chunks substantially simultaneously as aligned data. Various data output priorities for the memory controller include an oldest-first order, a round robin order, and an order based on a priority or tag associated with chunks of data.

### BACKGROUND

Parallel processors such as accelerator processors and graphics processing units (GPUs) conventionally implement graphics processing pipelines that concurrently process copies of commands that are retrieved from a command buffer. GPUs and other multithreaded processing units typically implement multiple processing elements (which may include processor cores, compute units, chiplets, or workgroup processors) that execute different programs or concurrently execute multiple instances of a single program on multiple data sets as a single “wave,” i.e., a group of threads running concurrently on a GPU. A hierarchical execution model is typically used to match the hierarchy implemented in hardware.

The execution model defines a kernel of instructions that are executed by one or more waves (also referred to as wavefronts, which may include one or more threads, streams, tasks, or work items). The graphics pipeline in a conventional GPU includes one or more shader engines that execute computer programs typically referred to as “shaders” using resources of the graphics pipeline such as compute units, memory, and caches. GPUs are traditionally used for graphical calculations, as implied by their name; however, in modern computing, shaders are often utilized as “compute shaders,” which function as general-purpose software that is able to perform work separately from a graphics processing pipeline. As GPU usage and machine learning applications have expanded over time, there is a necessity to improve the functionality and performance of GPUs.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system for generating aligned data from segmented data channels according to some implementations.

FIG. 2 is a block diagram of a high-bandwidth memory circuit according to some implementations.

FIG. 3 is a timing diagram illustrating buffer utilization in a high-bandwidth memory circuit according to some implementations.

FIG. 4 is another timing diagram illustrating buffer utilization in a high-bandwidth memory circuit according to some implementations.

FIG. 5 is a flow diagram of a method of generating aligned data from segmented data channels according to some implementations.

FIG. 6 is a flow diagram of another method of generating aligned data from segmented data channels according to some implementations.

### DETAILED DESCRIPTION

A parallel processor such as an accelerated processing device or graphics processing unit (GPU) typically includes a plurality of “shader engines,” where each shader engine includes a respective quantity of compute units, and a command processor (CP) coupled to the plurality of shader engines. The CP receives one or more commands for execution and generates the plurality of workgroups or tasks (e.g., processing threads or collections of threads corresponding to one or more programs) based on the one or more commands. Assigning each workgroup to a respective shader engine may include dynamically assigning each workgroup to a respective shader engine via an interface such as a shader program interface, which acts as a scheduler, associated with the respective shader engine.

As GPU usage for executing compute shaders, machine learning applications, and other general-purpose applications has expanded over time, in order to provide a GPU with the flexibility to execute tasks related to a graphics processing pipeline, machine learning, or other advanced computing applications in an efficient manner, GPUs implemented in accordance with the teachings of the present disclosure include a plurality of parallel processing chiplets (PPCs). In some implementations, the PPCs are configured to process tasks and function as advanced GPU chiplets in that they offer one or more of parallel processing functionality, optimized GPU functionality, and optimized processing for advanced applications that utilize, e.g., reduced precision data common in machine learning. The PPCs are able to execute instructions separately or in parallel and, in some implementations, share a single pool of virtual and physical memory with extremely low latency.

Data in memory is often stored or transmitted in chunks, such as 16-byte, 32-byte, or 64-byte chunks, and so on. For example, in some implementations, a 64-byte value is transmitted from memory in 32-byte chunks. In some implementations, one or more PPCs are associated with, e.g., in close proximity to and/or sharing a chiplet with, one or more memories. In some implementations, the memories are configured to provide data for the one or more PPCs through two or more independent data channels. When data channels provide mismatched chunks, i.e., chunks of segmented data that are not associated with one another, the chunks are considered to be “unaligned.” If two or more data channels (sometimes referred to as “pseudochannels” when, e.g., the channels share a single command bus) provide independent data streams from memory, the task of processing the segmented, unaligned data in the data streams can lead to undesirable delays. For example, as the data channels in memory often operate independently or partially independently, the 32-byte chunks of a 64-byte value are often transmitted sequentially on a first channel while 32-byte chunks of a different 64-byte value are transmitted sequentially on a second channel. As a result, after receiving both 32-byte chunks of both 64-byte values, the 32-byte values often need to be appropriately concatenated and stored or forwarded as 64-byte values before subsequent processing can be performed. The additional delay introduced by the need to process individual segments of unaligned data into aligned data can undesirably limit the ability to increase processing and memory read speeds (e.g., processor and memory clock speeds).

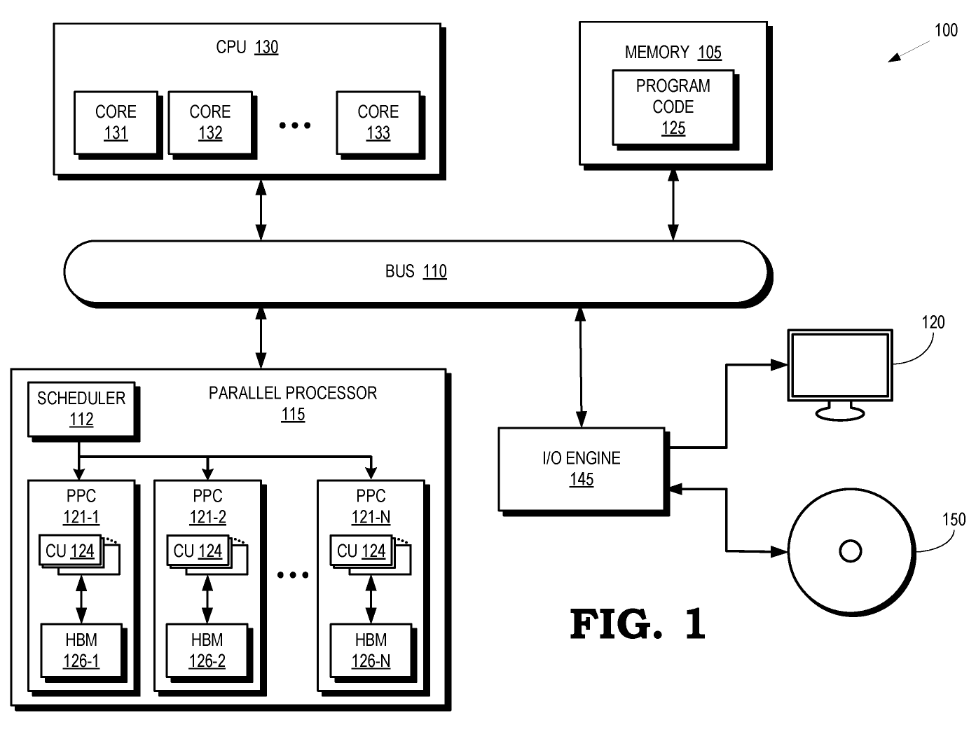

FIGS. 1-6 illustrate systems and techniques for generating aligned data from segmented data channels. In some implementations, a memory controller stores mismatched, segmented chunks of data received from a memory in buffers such that, once a complete set of chunks for a value requested from memory is received, the memory controller outputs all of the chunks substantially simultaneously as aligned data (i.e., data that is presented in its complete form and/or without any intervening, unrelated values on a single output bus or a number of output buses). By outputting aligned data rather than outputting mismatched chunks of segmented, unaligned data, the burden that may otherwise be placed on subsequent processing steps to align the chunks of data or otherwise select appropriate chunks of data for processing is reduced or eliminated. Additionally, memory clock speed can be increased without placing undue burden on the memory controller, as, in some implementations, the memory controller includes a clock that operates at approximately 50% of the frequency of the memory clock. By utilizing buffers and aligning data for output as it becomes available, the memory controller reduces upstream processing requirements while simultaneously allowing overall memory speed to be increased.

FIG. 1 is a block diagram of a processing system 100 generating aligned data from segmented data channels according to some implementations. The processing system 100 includes or has access to a memory 105 or other storage component that is implemented using a non-transitory computer readable medium such as a dynamic random-access memory (DRAM). However, in some cases, the memory 105 is implemented using other types of memory including static random-access memory (SRAM), nonvolatile RAM, and the like. The memory 105 is referred to as an external memory as it is implemented external to the processing units implemented in the processing system 100. The processing system 100 also includes a bus 110 to support communication between entities implemented in the processing system 100, such as the memory 105. Some implementations of the processing system 100 include other buses, bridges, switches, routers, and the like, which are not shown in FIG. 1 in the interest of clarity.

The techniques described herein are, in different implementations, employed at any of a variety of parallel processors (e.g., vector processors, GPUs, general-purpose GPUs (GPGPUs), non-scalar processors, highly parallel processors, artificial intelligence (AI) processors, inference engines, machine learning processors, other multithreaded processing units, and the like). FIG. 1 illustrates an example of a parallel processor 115, which is implemented in the illustrated example as a multi-chiplet processor, in accordance with some implementations. In some implementations, the parallel processor 115 renders images for presentation on a display 120. For example, the parallel processor 115 renders objects to produce values of pixels that are provided to the display 120, which uses the pixel values to display an image that represents the rendered objects. However, the parallel processor 115 is also capable of executing software not directly involved in any graphics processing pipeline, such as machine learning applications and other advanced computing applications.

In order to provide the parallel processor 115 with the flexibility to execute tasks related to a graphics processing pipeline, machine learning, or other advanced computing applications in an efficient manner, the parallel processor 115 includes a plurality of PPCs, such as PPCs 121-1, 121-2, and 121-N, which are configured to process tasks and offer one or more of GPU functionality and optimized processing for advanced applications that utilize, e.g., reduced precision data common in machine learning. By providing the parallel processor 115 with a plurality of PPCs 121, the parallel processor 115 is able to perform a number of tasks simultaneously while latency and data transfer energy between the PPCs 121 is minimized. The PPCs 121 are typically implemented using shared hardware resources of the parallel processor 115, such as compute units 124. In some implementations, the PPCs 121 are used to implement shaders, such as geometry shaders, pixel shaders, and the like. Generally, the PPCs 121 are a logical grouping of processing hardware, which in some implementations includes, e.g., one or more processing chiplets, cores, and/or caches. The PPCs 121 typically include or access a number of compute units 124 in the parallel processor 115, and each of the compute units 124 typically includes a number of single-instruction-multiple-data (SIMD) units. The number of PPCs 121 implemented in the parallel processor 115 is a matter of design choice and some implementations of the parallel processor 115 include more or fewer PPCs than are shown in FIG. 1. In order to provide efficient task and data assignment in a multi-chiplet processor such as the parallel processor 115, the parallel processor 115 includes one or more memories, e.g., high-bandwidth memories (HBMs) 126-1, 126-2, and 126-N, associated with, e.g., in close proximity to and/or sharing a chiplet with, a respective one or more of the plurality of PPCs 121.

In some implementations, the processing system 100 also includes a CPU 130 that is connected to the bus 110 through which it communicates with the parallel processor 115 and the memory 105. The CPU 130 implements a plurality of processor cores 131, 132, 133 (collectively referred to herein as “processor cores 131-133”) that execute instructions concurrently or in parallel. The number of processor cores 131-133 implemented in the CPU 130 is a matter of design choice and some implementations include more or fewer processor cores than are illustrated in FIG. 1. The processor cores 131-133 execute instructions such as program code 125 stored in the memory 105 and the CPU 130 stores information in the memory 105 such as the results of the executed instructions (e.g., data). The CPU 130 is also able to initiate graphics or other processing by issuing draw calls or other tasks to the parallel processor 115.

As shown in FIG. 1, the parallel processor 115 further includes a scheduler 112, sometimes referred to as a sequencer, which is implemented as any cooperating collection of hardware, software, or a combination thereof that performs functions and computations associated with assigning threads, workgroups, waves, or other tasks, such as compute shader threads, to one or more of the PPCs 121. In some implementations, one or more schedulers or sequencers are incorporated into one or more PPCs and/or compute units 124. In some implementations, one or more of the PPCs 121 are able to be selectively addressed or controlled independently from one another or addressed or controlled in groups of two or more such that the parallel processor 115, the scheduler 112, and/or a user is able to control which PPCs 121 perform specific tasks or to distribute tasks across a number of PPCs 121. In some implementations, the parallel processor 115 is used for general purpose computing.

As noted above, one or more PPCs 115 includes one or more HBMs 126. In some implementations, the HBMs 126 are configured to provide data for the one or more PPCs 121 through two or more independent data channels. However, as also noted above, when two or more data channels (sometimes referred to as “pseudochannels” when, e.g., the channels share a single command bus) provide independent data streams from memory, the task of processing the segmented, unaligned data in the data streams can lead to undesirable delays. In order to increase overall memory read speed without introducing undesirable delays, in some implementations, at least one of the CPU 130, parallel processor 115, PPCs 121, and HBMs 126 includes hardware and/or software configured to generate aligned data from segmented, unaligned data channels.

As described further hereinbelow, in some implementations, as a memory controller receives segmented, unaligned chunks of data from memory, the memory controller stores the chunks in one or more buffers. After receiving all of the associated chunks of data from memory for a particular piece of memory requested by, e.g., a PPC 121, such as an upper 32-byte chunk and a lower 32-byte chunk of data that together represent a single 64-byte value, the controller outputs the 64-byte value as an aligned value generated by, e.g., concatenating the upper and lower 32-byte chunks of data. In some implementations, the 64-byte value is output as segmented, aligned chunks of memory, i.e., 32-byte chunks output simultaneously on separate channels. Although examples of 64-byte values with 32-byte chunks are described herein, it will be appreciated that aspects of the present disclosure are applicable to other values, such as 32-byte values with 16-byte chunks or 128-byte values with 64-byte chunks. Similarly, although examples of values split into two chunks of data are described herein, it will be appreciated that aspects of the present disclosure are applicable to higher numbers of chunks of data, such as values split into three or more chunks.

An input/output (I/O) engine 145 handles input or output operations associated with the display 120, as well as other elements of the processing system 100 such as keyboards, mice, printers, external disks, and the like. The I/O engine 145 is coupled to the bus 110 so that the I/O engine 145 communicates with the memory 105, the parallel processor 115, or the CPU 130. In the illustrated implementation, the I/O engine 145 reads information stored on an external storage component 150, which is implemented using a non-transitory computer readable medium such as a compact disk (CD), a digital video disc (DVD), and the like. The I/O engine 145 is also able to write information to the external storage component 150, such as the results of processing by the parallel processor 115 or the CPU 130.

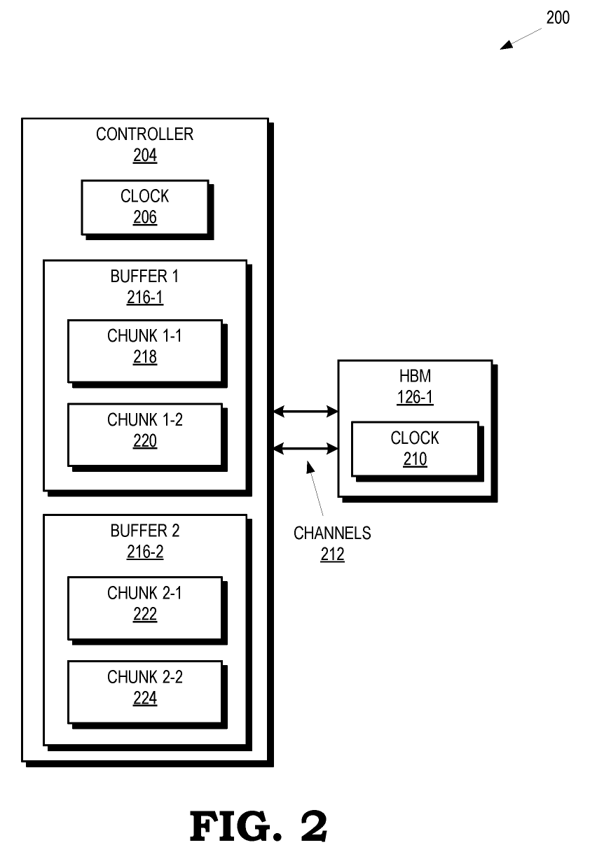

FIG. 2 is a block diagram of a circuit 200 in a parallel processor, such as the parallel processor 115 of FIG. 1, according to some implementations. As shown in FIG. 2, the circuit 200 includes a memory controller 204, which operates on the basis of a controller clock 206, and an HBM 126-1, which operates on the basis of a memory clock 210. The HBM 126-1 transmits data, which is often segmented and unaligned, to the controller 204 via a plurality of independent channels 212 (or partially independent, e.g., pseudochannels with a shared command bus but independent data buses). After receiving segmented data from the HBM 126-1 through the channels 212, the controller 204 stores the segmented data in one or more buffers, such buffer 1 216-1 and buffer 2 216-2.

In some implementations, the controller 204 stores chunks of data in particular buffers 216 based on the characteristics of the data. For example, in some implementations, the controller 204 stores chunks of data in specific buffers based on a priority, identifier tag(s) identifying associated chunks of data, or other indicator associated with a chunk of data. In some implementations, the controller 204 stores chunks of data associated with specific channels 212 in specific buffers 216. For example, in some implementations, the controller 204 stores first and second chunks of a first piece of data received from a first memory channel 212 as chunk 1-1 218 and chunk 1-2 220, respectively, in buffer 1 216-1. Similarly, in this example, the controller 204 stores first and second chunks of a second piece of data received from a second memory channel 212 as chunk 2-1 222 and chunk 2-2 224, respectively, in buffer 2 216-2. In some implementations, data from a first channel or pseudochannel is stored into buffer 1 216-1 while data from a second channel or pseudochannel is stored into buffer 2 216-2, e.g., in one cycle of the controller clock 206. In some implementations, the controller 204 includes more than two buffers when, e.g., more than two channels transmit data from the HBM 126-1 to the controller 204, more than two tags are to be stored in dedicated buffers, and/or a larger bit width is desired to be output. For example, if 32-byte chunks of data are received from memory and 128-byte values are to be output from the controller 204, larger buffers 216 or a larger number of buffers 216 are included in the HBM 126-1.

After receiving all of the associated chunks of data from memory for a particular piece of memory requested by, e.g., a PPC 121, such as an upper 32-byte chunk and a lower 32-byte chunk of data that together represent a single 64-byte value, the controller 204 generates aligned data from the segmented data by concatenating upper and lower 32-byte chunks of segmented data, and then outputs the 64-byte value as an aligned value. In some implementations, the 64-byte value is output as segmented, aligned chunks of memory, i.e., 32-byte chunks output substantially simultaneously on separate channels 212. As noted above, although examples of 64-byte values with 32-byte chunks are described herein, it will be appreciated that aspects of the present disclosure are applicable to other values, such as 32-byte values with 16-byte chunks or 128-byte values with 64-byte chunks. Similarly, although examples of values split into two chunks of data are described herein, it will be appreciated that aspects of the present disclosure are applicable to higher numbers of chunks of data, such as values split into three or more chunks.

As noted above, the controller 204 includes a controller clock 206 and the HBM 126-1 include the memory clock 210. In some embodiments, aspects of the present disclosure enable the memory clock 210 to run at a substantially higher frequency than the controller clock 206. For example, by storing segmented, unaligned values received from memory in buffers 216 in the memory controller 204 and outputting aligned values, the amount of additional processing (and therefore latency or time) that would otherwise be required to process the data received from the HBM 126-1 can be limited. In effect, this allows for the memory clock 210 to be increased, which increases the overall read speed for the HBM 126-1, without significantly impacting the performance or latency of subsequent processing. For example, in some implementations, the HBM memory clock 210 runs at approximately 1.8-2.2 times faster than the controller clock 206.

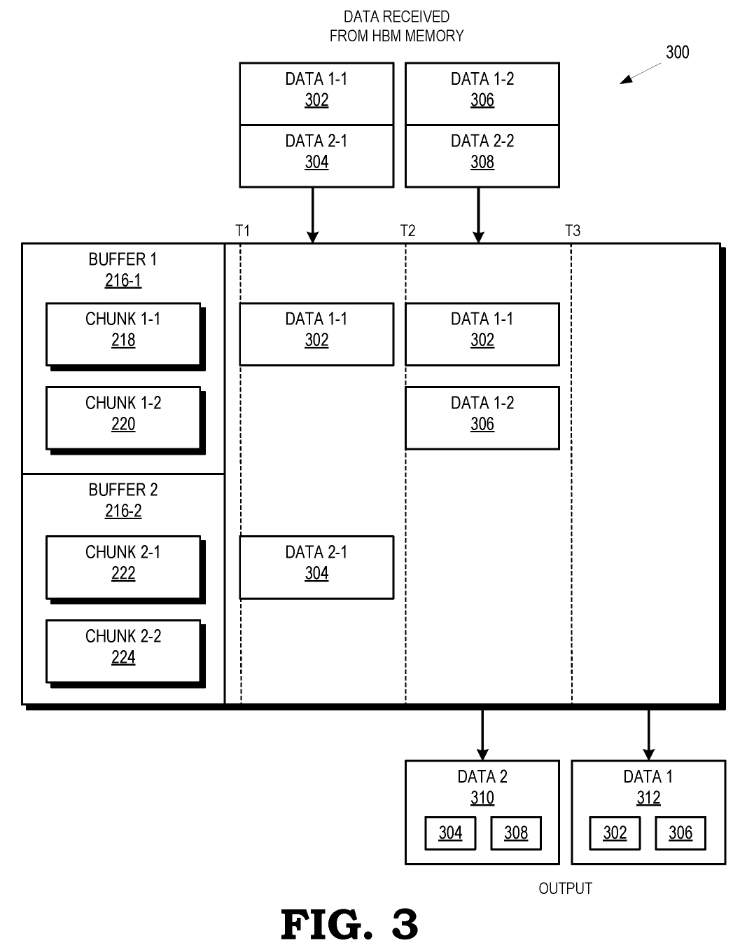

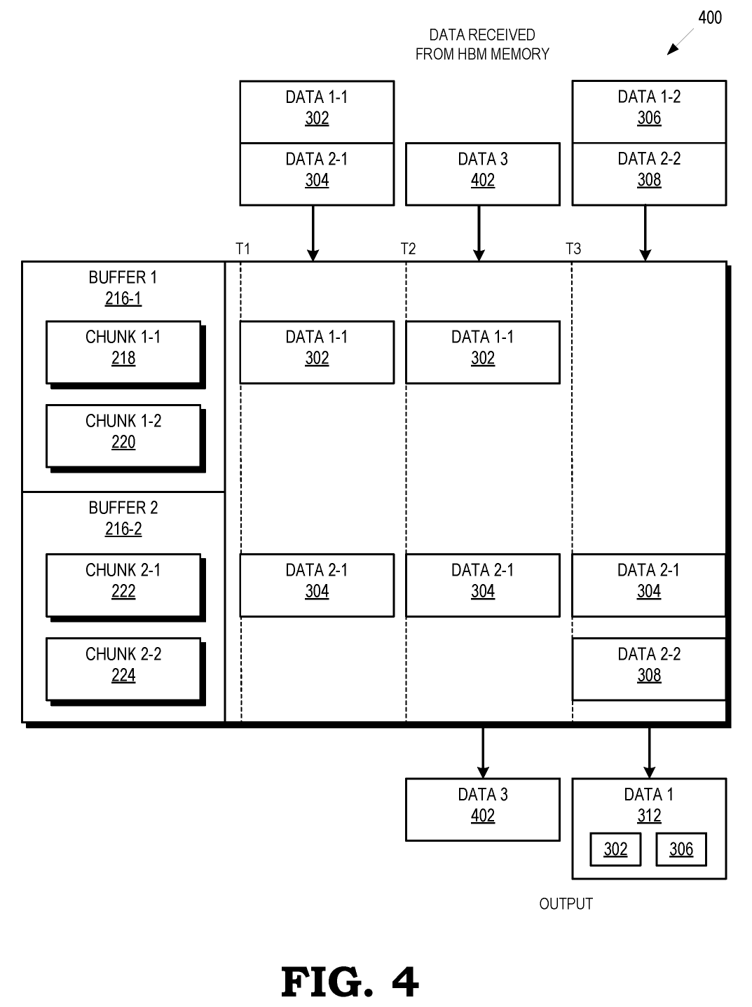

As described above and further hereinbelow with reference to FIGS. 3 and 4, the memory controller 204 is configured to receive a first portion of segmented, unaligned data from the HBM 126-1 and store the first portion of segmented data in the one or more buffers 216. The memory controller 204 is configured to then receive a second portion of segmented data associated with data in the first portion of segmented data from the HBM 126-1 and output aligned data selected from the first portion and second portion of segmented data. In some implementations, the one or more buffers 216 include a first buffer, buffer 1 216-1, and a second buffer, buffer 2 216-2, and the controller 204 stores the segmented data received from a first one of the channels 212 in buffer 1 216-1 and stores the segmented data received from a second one of the channels 212 in buffer 2 216-2. However, in some implementations, the controller 204 outputs data without storing it in the one or more buffers 216. For example, when the controller 204 has already stored a first segmented, unaligned chunk of data in a buffer 216 and the HBM 126-1 transmit a second segmented chunk of data associated with the first segmented chunk of data, in some implementations, the controller 204 outputs the first and second chunks of data as aligned data without first storing the second segmented chunk of data in the buffer 216. Additionally, in some implementations, the controller 204 outputs non-segmented data prior to outputting aligned data. For example, if the controller 204 receives a 32-byte non-segmented (i.e., not associated with any other chunks of data) chunk of data from the HBM 126-1, in some implementations, the controller 204 outputs the non-segmented chunk of data immediately without first storing it in a buffer 216. In some implementations, the controller 204 stores the non-segmented chunk of data in a buffer 216 but still outputs the non-segmented chunk prior to other aligned data. However, it will be appreciated that different chunks of segmented or non-segmented chunks of data are prioritized in different ways in different implementations. For example, in some implementations, data is output in an oldest-first order, a round robin order, an order based on a priority or tag associated with chunks of data, and/or any other desired order.

FIG. 3 is a timing diagram 300 illustrating buffer utilization in a high-bandwidth memory circuit, such as the circuit 200 of FIG. 2, according to some implementations. As shown in FIG. 3, at time T1, when the controller 204 receives data 1-1 302 and data 2-1 304 (e.g., each from an individual data channel 212), the controller 204 stores the data 1-1 302 as chunk 1-1 218 in buffer 1 216-1. Similarly, the controller 204 stores the data 2-1 304 as chunk 2-1 222 in buffer 1 216-2. In some implementations, the chunks of data, e.g., data 1-1 302 and data 2-1 304, include or are associated with one or more tags or other indicators of whether the chunks of data are segmented and/or associated with other chunks of data. At time T2, when the controller 204 receives data 1-2 306 and data 2-2308 (e.g., each from an individual data channel 212), the controller 204 stores the data 1-2 306 as chunk 1-2 220 in buffer 1 216-1. However, rather than storing the received data 2-2 308 in a buffer 216, the controller 204 recognizes (e.g., based on one or more tags or other indicators in or associated with the chunks of data) that data 2-2 308 is the last chunk of data associated with data 2-1 304 and therefore outputs data 2-2 308 with data 2-1 304 as aligned data 2 310. At time T3, the controller 204 outputs aligned data 1312 as a concatenation of data 1-1 302 and data 1-2 306. Notably, as all of the chunks for data 1 312 and data 2310 were received by time T2, either data 1312 or data 2310 can be output at time T2 with the other output at time T3. If additional output channels and/or buses are available, both data 1312 and data 2310 are output at time T2.

FIG. 4 is another timing diagram 400 illustrating buffer utilization in a high-bandwidth memory circuit, such as the circuit 200 of FIG. 2, according to some implementations. The example of FIG. 4 is similar to that of FIG. 3; however, at time T2, the controller 204 receives unsegmented data 3402 (i.e., standalone data not associated with any other data) from the HBM 126-1. As the controller 204 does not need to wait for any other chunks of data to generate aligned data with data 3402 and no other data is yet ready for output (i.e., data 2-1 304 and data 2-2 308 have not yet been received) in some implementations, the controller 204 outputs data 3402 substantially immediately, e.g., without storing data 3 402 in the buffers 216, as data 3402. Subsequently, at time T3, the controller 204 outputs aligned data 1312 based on data 1-1 302 and data 1-2 306, and, although not shown in FIG. 4, outputs data 2310 after time T3. Notably, in FIG. 4, when the controller 204 has all of the chunks of data for data 1312 and data 2310, in the example of FIG. 4, data 1312 is output first, while in FIG. 3 in a similar situation, data 2310 is output first. As noted above, in some implementations, the order of output of aligned and/or non-segmented data (e.g., requested memory values for which all the data chunks have been received) from the controller 204 is in an oldest-first order, a round robin order, an order based on a priority or tag associated with chunks of data, and/or any other desired order.

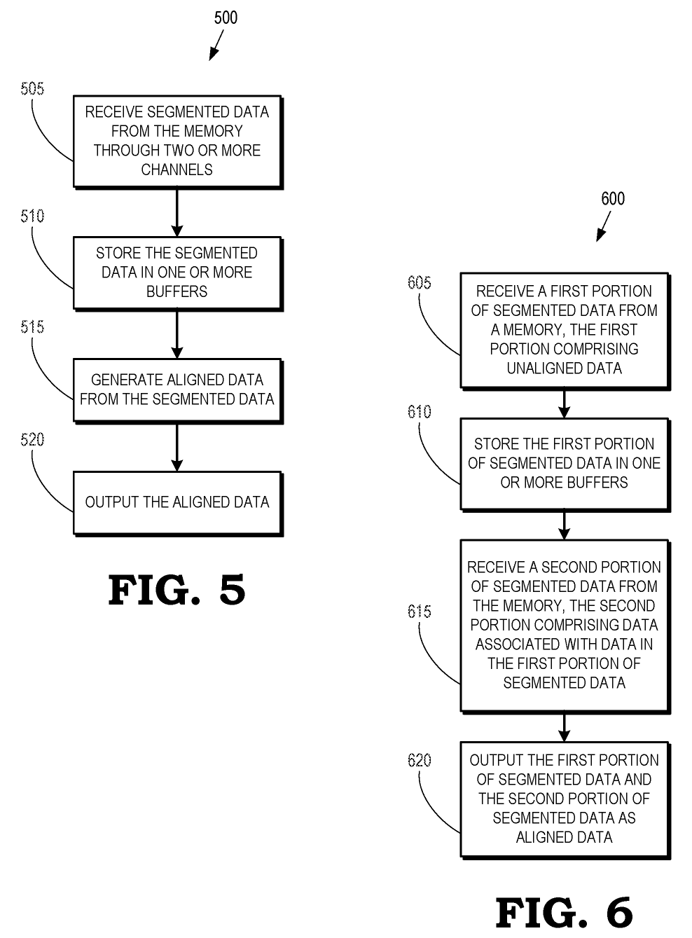

FIG. 5 is a flow diagram of a method 500 of generating aligned data from segmented data channels according to some implementations. At block 505, a controller such as the controller 204 of FIG. 2 receives segmented data from a memory through two or more channels, or pseudochannels, such as the channels 212 of FIG. 2. At block 510, the controller stores the segmented data in one or more buffers, such as one of the buffers 216 of FIG. 2. At block 515, the controller generates aligned data (see, e.g., aligned data 1 312 and aligned data 2 310 in FIG. 3) from the segmented data (e.g., data 1-1 302 and data 2-1 304 in FIG. 3), and, at block 520, the controller outputs the aligned data. In some implementations, the controller receives a first portion of segmented, unaligned data (e.g., data 1-1 302 in FIG. 3) from a memory, stores the first portion of segmented data in one or more buffers (e.g., buffer 216-1), and then receives a second portion of segmented data (e.g., data 1-2 304 in FIG. 3) from the memory. In some implementations, the second portion of segmented data is associated with data in the first portion of segmented data. For example, in some implementations, the second portion of segmented data is associated with the first portion using one or more tags or other metadata stored separately or as part of the portions of segmented data. In some implementations, the controller outputs the first portion of segmented data and the second portion of segmented data as aligned data (e.g., aligned data 1 312 and aligned data 2 310 in FIG. 3). In some implementations, receiving the first portion and the second portion of segmented data from memory comprises receiving the segmented data from the memory through two or more channels, such as the channels 212 of FIG. 2. In some implementations, outputting the aligned data comprises outputting the second portion of the segmented data without storing the second portion of the segmented data in the one or more buffers (see, e.g., FIG. 3, where the controller outputs data 2-2 308 without first storing it in the buffers 216).

FIG. 6 is a flow diagram of another method 600 of generating aligned data from segmented data channels, such as the channels 212 of FIG. 2, according to some implementations. At block 605, a controller such as the controller 204 of FIG. 2 receives a first portion of segmented data from a memory, the first portion comprising unaligned data. At block 610, the controller stores the first portion of segmented data in one or more buffers. At block 615, the controller receives a second portion of segmented data from the memory, the second portion comprising data associated with data in the first portion of segmented data. At block 620, the controller outputs aligned data, wherein the aligned data is selected from the first portion and second portion of segmented data. As discussed in further detail hereinabove, e.g., with reference to FIG. 3, in some implementations, outputting the aligned data comprises outputting the second portion of the segmented data without storing the second portion of the segmented data in the one or more buffers. In some implementations, the method 600 further comprises receiving non-segmented data from the memory after receiving the first portion of the segmented data and outputting the non-segmented data prior to outputting the aligned data, as shown in FIG. 4 with data 3402. In some implementations, receiving the first portion and the second portion of segmented data from memory comprises receiving the segmented data from the memory through two or more channels or pseudochannels, such as the channels 212 of FIG. 2.

In some implementations, the one or more buffers include a first buffer and a second buffer, and storing the first portion of segmented data in one or more buffers further comprises storing segmented data received from a first one of the channels in the first buffer and storing segmented data received from a second one of the channels in the second buffer. In some implementations, the controller utilizes the first buffer exclusively for storing data received from the first one of the channels and utilizes the second buffer exclusively for storing data received from the second one of the channels. For example, as shown in FIG. 2, the controller 204 includes buffer 1 216-1 and buffer 2 216-2. In some implementations, the controller exclusively stores data received from a first channel in buffer 1 216-1 and exclusively stores data received from a second channel in buffer 2 216-2. In some implementations, receiving the first portion of segmented data from the memory comprises receiving an unaligned set of first segmented data and second segmented data, such as data 1-1 302 and data 2-1 304 of FIGS. 3 and 4. In some implementations, receiving the second portion of segmented data from the memory comprises receiving an unaligned set of third segmented data and fourth segmented data, wherein the first segmented data (e.g., data 1-1 302 in FIG. 3) is associated with the third segmented data (e.g., data 1-2 306).

In some implementations, the apparatus and techniques described above are implemented in a system including one or more integrated circuit (IC) devices (also referred to as integrated circuit packages or microchips), such as the CPU 130, parallel processor 115, PPCs 121, HBMs 126, and memory controllers 204 described above with reference to FIGS. 1-6. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc , magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some implementations, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

One or more of the elements described above is circuitry designed and configured to perform the corresponding operations described above. Such circuitry, in at least some implementations, is any one of, or a combination of, a hardcoded circuit (e.g., a corresponding portion of an application specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some implementations, the circuitry for a particular element is selected, arranged, and configured by one or more computer-implemented design tools. For example, in some implementations the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry,” “engines,” “workgroups,” “launchers,” “interfaces,” “chiplets,” etc.) are described or claimed as “configured” to perform one or more tasks or operations. This formulation of “[entity] configured to [perform one or more tasks]” is used herein to refer to structure (e.g., a physical element, such as electronic circuitry, or an algorithm in software executed by such a physical element). More specifically, this formulation is used to indicate that this physical structure is arranged to perform the one or more tasks during operation. A structure can be said to be “configured to” perform some task even if the structure is not currently being operated. Thus, an entity described or recited as “configured to” perform some task refers to a physical element, such as a device, circuitry, memory storing program instructions executable to implement the task, or an algorithm executed using such a physical element. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that may cause any benefit, advantage, or solution to occur or become more pronounced are not to be construed as a critical, required, or essential feature of any or all the claims. Moreover, the particular implementations disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular implementations disclosed above may be altered or modified and all such variations are considered within the scope of the disclosed subject matter. Accordingly, the protection sought herein is as set forth in the claims below.

What is claimed is:

1. An apparatus comprising:
a memory; and
a memory controller configured to:
receive segmented data from the memory through two or more channels;
store the segmented data in one or more buffers;
generate aligned data from the segmented data; and
output the aligned data.

2. The apparatus of claim 1, wherein the memory includes a first clock configured to run at a first frequency and the memory controller includes a second clock configured to run at a second frequency lower than the first frequency.

3. The apparatus of claim 1, wherein the memory controller is further configured to:
receive a first portion of the segmented data from the memory, the first portion comprising unaligned data;
store the first portion of the segmented data in the one or more buffers;
receive a second portion of the segmented data from the memory, the second portion comprising data associated with the first portion of segmented data; and
output the aligned data, wherein the aligned data is selected from the first portion and second portion of segmented data.

4. The apparatus of claim 3, wherein outputting the aligned data comprises outputting the second portion of the segmented data without storing the second portion of the segmented data in the one or more buffers.

5. The apparatus of claim 3, wherein the memory controller is further configured to:
receive non-segmented data from the memory after receiving the first portion of the segmented data; and
output the non-segmented data prior to outputting the aligned data.

6. The apparatus of claim 3, wherein the one or more buffers include a first buffer and a second buffer, and wherein storing the segmented data in one or more buffers further comprises storing the segmented data received from a first channel of the two or more channels in the first buffer and storing the segmented data received from a second channel of the two or more channels in the second buffer.

7. The apparatus of claim 6, wherein the first buffer is utilized exclusively for storing data received from the first channel and the second buffer is utilized exclusively for storing data received from the second channel.

8. The apparatus of claim 1, further comprising a processor associated with the memory, wherein the processor is configured to receive the aligned data and execute one or more program instructions using the aligned data.

9. A method, comprising:
receiving a first portion of segmented data from a memory, the first portion comprising unaligned data;
storing the first portion of segmented data in one or more buffers;
receiving a second portion of segmented data from the memory, the second portion comprising data associated with the first portion of segmented data; and
output aligned data, wherein the aligned data is selected from the first portion and second portion of segmented data.

10. The method of claim 9, wherein outputting the aligned data comprises outputting the second portion of the segmented data without storing the second portion of the segmented data in the one or more buffers.

11. The method of claim 9, further comprising:
receiving non-segmented data from the memory after receiving the first portion of the segmented data; and
outputting the non-segmented data prior to outputting the aligned data.

12. The method of claim 9, wherein receiving the first portion and the second portion of segmented data from memory comprises receiving the segmented data from the memory through two or more channels.

13. The method of claim 12, wherein the one or more buffers include a first buffer and a second buffer, and wherein storing the first portion of segmented data in one or more buffers further comprises storing segmented data received from a first one of the channels in the first buffer and storing segmented data received from a second one of the channels in the second buffer.

14. The method of claim 13, further comprising utilizing the first buffer exclusively for storing data received from the first one of the channels and utilizing the second buffer exclusively for storing data received from the second one of the channels.

15. The method of claim 9, wherein receiving the first portion of segmented data from the memory comprises receiving an unaligned set of first segmented data and second segmented data.

16. The method of claim 15, wherein receiving the second portion of segmented data from the memory comprises receiving an unaligned set of third segmented data and fourth segmented data, wherein the first segmented data is associated with the third segmented data.

17. A method, comprising:
receiving segmented data from a memory through two or more channels;
storing the segmented data in one or more buffers;
generating aligned data from the segmented data; and
outputting the aligned data.

18. The method of claim 17, further comprising:
receiving a first portion of segmented data from a memory, the first portion comprising unaligned data;
storing the first portion of segmented data in one or more buffers;
receiving a second portion of segmented data from the memory, the second portion comprising data associated with data in the first portion of segmented data; and
outputting the first portion of segmented data and the second portion of segmented data as aligned data.

19. The method of claim 18, wherein receiving the first portion and the second portion of segmented data from memory comprises receiving the segmented data from the memory through two or more channels.

20. The method of claim 18, wherein outputting the aligned data comprises outputting the second portion of the segmented data without storing the second portion of the segmented data in the one or more buffers.
